(19) United States
(12) Patent Application Publication
(10) Pub. No.: US 2013/0254107 A1
(43) Pub. Date: Sep. 26, 2013

(54) System and Method for Transferring Funds Over Mobile Technology Platforms Between Participants in a Face-to-Face Transaction

(71) Applicant: Joshua McClure, Austin, TX (US)

(72) Inventor: Joshua McClure, Austin, TX (US)

(21) Appl. No.: 13/544,062

(22) Filed: Jul. 9, 2012

Related U.S. Application Data
(60) Provisional application No. 61/612,974, filed on Mar. 20, 2012.

(51) Int. Cl. G06Q 40/00

(52) U.S. Cl. 705/42

(57) ABSTRACT

A system is provided for transferring funds between first and second participants to a face-to-face transaction. The system includes a software program, a first instance of which is installed on a first mobile communications device (401) associated with the first participant, and a second instance of which is on a second device (451) associated with the second participant. The program allows the second participant to receive an offer of payment (405) sent by the first participant from the first mobile communications device such that the offer is displayed on the second device. The offer indicates the amount of payment (409) associated with the offer, contains an image (407) of the first participant, and is accompanied by an acceptance indicia which, when selected by the second participant, results in the transfer of funds from an account associated with the first participant to an account associated with the second participant.

### CROSS-REFERENCE TO RELATED APPLICATIONS

This application claims priority to U.S. Provisional Application Ser. No. 61/612,974 (McClure), entitled “System and Method for Transferring Funds Over Mobile Technology Platforms Between Participants in a Face-To-Face transaction”, which was filed on Mar. 20, 2012, and which is incorporated herein by reference in its entirety.

### FIELD OF THE DISCLOSURE

The present disclosure relates generally to systems and methods for transferring funds, and more particularly to systems and methods for making an electronic payment as part of a face-to-face transaction.

### BACKGROUND OF THE DISCLOSURE

As mobile technology platforms become more ubiquitous, systems which utilize these devices to conduct financial transactions have become more prevalent. At present, for example, systems and software have been developed which allow users of these devices to access brokerage accounts, conduct online banking, and handle various other financial transactions. Typically, these systems and programs rely on various types of encryption and authentication technologies to ensure that the transactions remain secure and to verify the identities of the parties to such transactions.

### BRIEF DESCRIPTION OF THE DRAWINGS

FIG. 1 is an illustration of a first embodiment of a system in accordance with the teachings herein.

FIG. 2 is an illustration of a second embodiment of a system in accordance with the teachings herein.

FIG. 3 is a flowchart of an embodiment of a method in accordance with the teachings herein.

FIGS. 4-32 are screenshots of an embodiment of a software program which implements some of the methodologies disclosed herein.

FIGS. 4-11 are screenshots of an embodiment of a software program which implements some of the methodologies disclosed herein, and which illustrate the manner in which a consumer uses the software to pay a vendor.

FIGS. 12-24 are screenshots of an embodiment of a software program which implements some of the methodologies disclosed herein, and which illustrate the manner in which the vendor accepts the payment.

FIGS. 25-32 are screenshots of an embodiment of a software program which implements some of the methodologies disclosed herein, and which illustrate the manner in which a receipt is generated and transmitted to the consumer.

FIGS. 33 and 34 are illustrations of a particular, non-limiting embodiment of a qualifying motion on mobile technology platforms of the type depicted in FIGS. 4-32.

### SUMMARY OF THE DISCLOSURE

In one aspect, a system is provided for transferring funds between first and second participants to a face-to-face transaction. The system comprises a software program, a first instance of which is installed in a first non-transitory, computer readable medium disposed on a first mobile communications device associated with the first participant, and a second instance of which is installed in a second non-transitory, computer readable medium disposed on a second device associated with the second participant; wherein said software program contains suitable programming instructions which, when executed, allow the second participant to receive an offer of payment sent by the first participant from the first mobile communications device such that the offer is displayed on the second device, wherein said offer indicates the amount of payment associated with the offer and contains an image of the first participant, and wherein said offer is accompanied by an acceptance indicia which, when selected by the second participant, results in the transfer of funds from an account associated with the first participant to an account associated with the second participant.

In another aspect, a method is provided for consummating a financial transaction between first and second parties in a face-to-face setting, wherein the first and second parties have first and second technology platforms associated with them, respectively, and wherein the first technology platform is a mobile technology platform. The method comprises (a) receiving, on the second technology platform, an offer transmitted by the first party from the first technology platform, the offer having associated therewith an indicated amount and a photo of the first party; and (b) accepting the offer.

In a further aspect, a method is provided for consummating a financial transaction between first and second parties in a face-to-face setting, wherein the first and second parties have first and second technology platforms associated with them, respectively, and wherein the first technology platform is a mobile technology platform. The method comprises (a) generating, on the first mobile technology platform, an offer having associated therewith an indicated amount and a photo of the first party; and (b) transmitting the offer to the second technology platform.

### DETAILED DESCRIPTION

Despite the need that exists in the art for the use of mobile technology platforms in conducting financial transactions, the systems and methodologies developed to date have some notably infirmities. In particular, these systems and methodologies do not replicate the type of experience a user enjoys in making cash-based transactions, and in particular, the ease and simplicity of such transactions. Rather, the systems and methods developed to date typically require the user to undertake various extra steps, such as logging into a special account, in order to make a transaction. Hence, a need exists in the art which overcome these infirmities.

It has now been found that the foregoing need may be met through the systems and methodologies disclosed herein. In a preferred embodiment, these systems and methodologies leverage the security provided by a face-to-face transaction to consummate a transfer of funds as part of a purchase or other financial transaction. The transfer of funds is consummated by the extension of an electronic offer for payment in an indicated amount by one party, and the acceptance of that offer by another party. The offer may be extended and accepted by way of a software application, instances of which may be resident on devices (such as mobile technology platforms, registers, PCs and the like) associated with each party to the transaction.

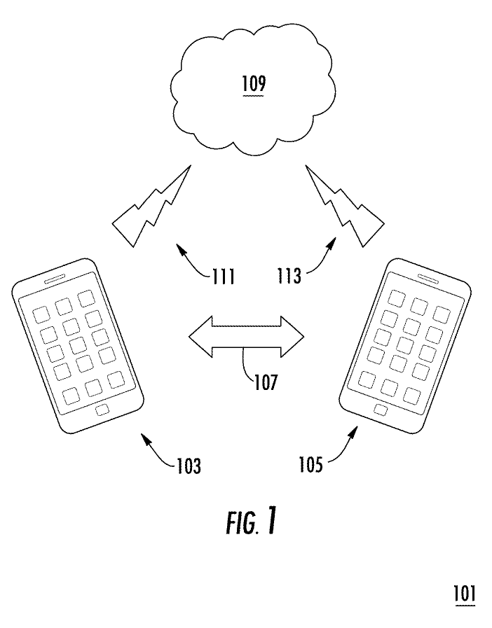

FIG. 1 illustrates an example of the use of a first particular, non-limiting embodiment of a system 101 for transferring funds in accordance with the teachings herein, where the transfer occurs between first and second parties to a face-to-face transaction. The parties in this particular embodiment are associated with first 103 and second 105 mobile technology platforms, respectively. The first 103 and second 105 mobile technology platforms may be capable of establishing a communications link 107 directly (e.g., through the use of the Bluetooth protocol), but preferably communicate by establishing first 111 and second 113 links to a communications network 109.

In the foregoing embodiment, the offer may be transmitted from the first mobile technology platform as a visible image that includes the amount of the offer and a photo of the first party for identification purposes. The offer then appears on the display of the second mobile technology platform. The second party may then compare the photo accompanying the offer to the first party so as to verify that they match. If the second party is satisfied as to the identity of the first party and wishes to accept the offer, then the second party may indicate acceptance of the offer. Upon doing so, funds in the amount of the offer will be transferred from an account associated with the first party to an account associated with the second party, thus consummating the transaction. If the second party declines the offer, the transaction is terminated. Preferably, an indication of acceptance forms a binding contract, so that upon acceptance, the offer cannot be revoked without the mutual consent of both parties.

It will be appreciated that the foregoing methodology is both secure and simple to use. In particular, security is provided by the fact that the parties are engaged in a face-to-face transaction in which the party receiving the offer (the second party) can compare the photo accompanying the offer to the actual individual present, thereby verifying that they are the same. Moreover, security is enhanced by the timeliness of an offer and the context in which it occurs. In particular, since the parties are conducting a face-to-face transaction, the party receiving the offer will be expecting to receive the offer, and will expect that offer to be coming from the party on the other side of the transaction. Moreover, the party receiving the offer will expect the offer to be in the amount agreed upon. Hence, if any of these elements do not match up, the party receiving the offer will have an immediate indication that the offer is illegitimate or fraudulent.

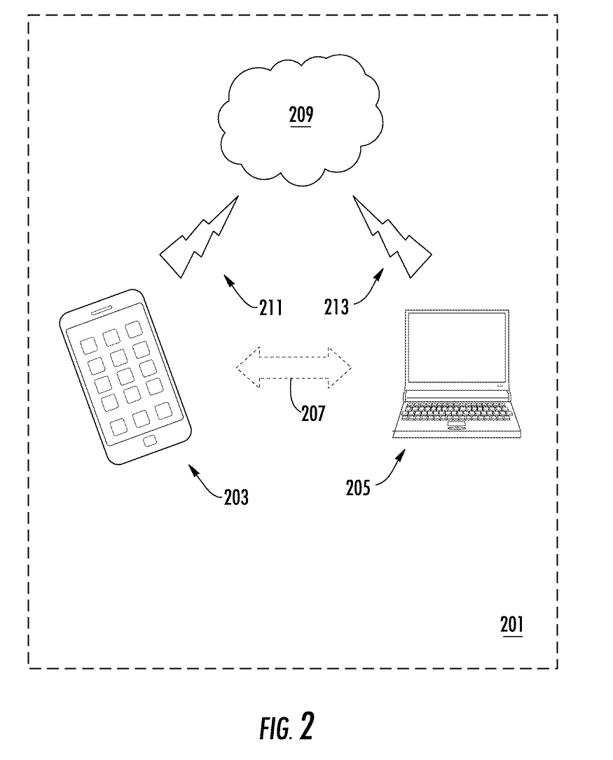

FIG. 2 illustrates an example of the use of a second particular, non-limiting embodiment of a system 201 for transferring funds in accordance with the teachings herein. The system 201 in this example is the same as system 101 of FIG. 1 except that, in this embodiment, only one mobile technology platform 203 is involved in the transaction, and the other device 205 is a laptop, a desktop PC, a register, or other such device. While the embodiment of FIG. 1 may be suitable for use by individuals, the embodiment of FIG. 2 may be more suitable for use in commercial settings involving, for example, a merchant and a customer.

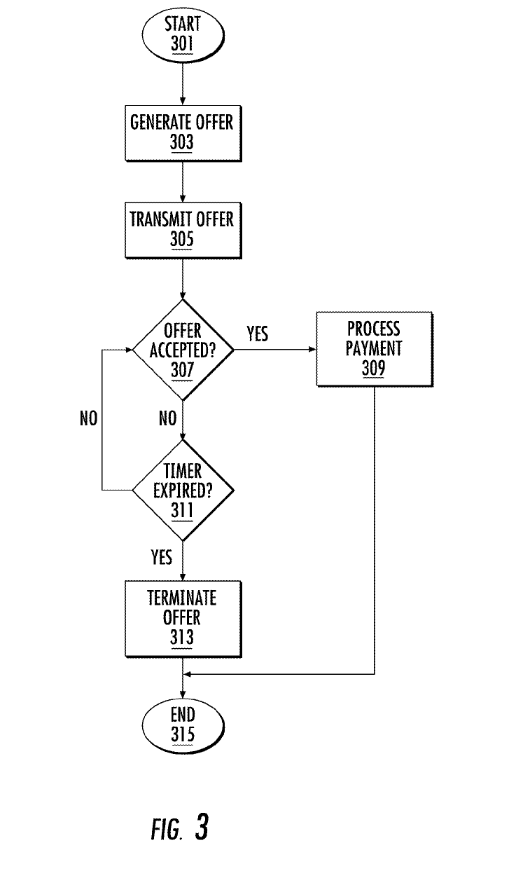

FIG. 3 illustrates an example of the use of a first particular, non-limiting embodiment of a method for transferring funds in accordance with the teachings herein. As seen therein, the method commences 301 with the first party generating 303 an offer of payment to the second party. The offer is then transmitted 305 to the second party using an established communications link. If the offer is accepted 307, then the payment from the first party to the second party is processed (in some implementations, this may involve several steps)), and the process terminates 315. If the offer is not accepted 307, then the process checks whether a timer has expired 311. Preferably, this timer will be started when the offer is transmitted, though it may be started at other times as well (for example, when the offer is created), and will expire in a predetermined amount of time. If the timer has expired 311, then the offer is cancelled 313, and the process terminates 315. If the timer has not expired 311, the process loops back to the offer accepted stage 307.

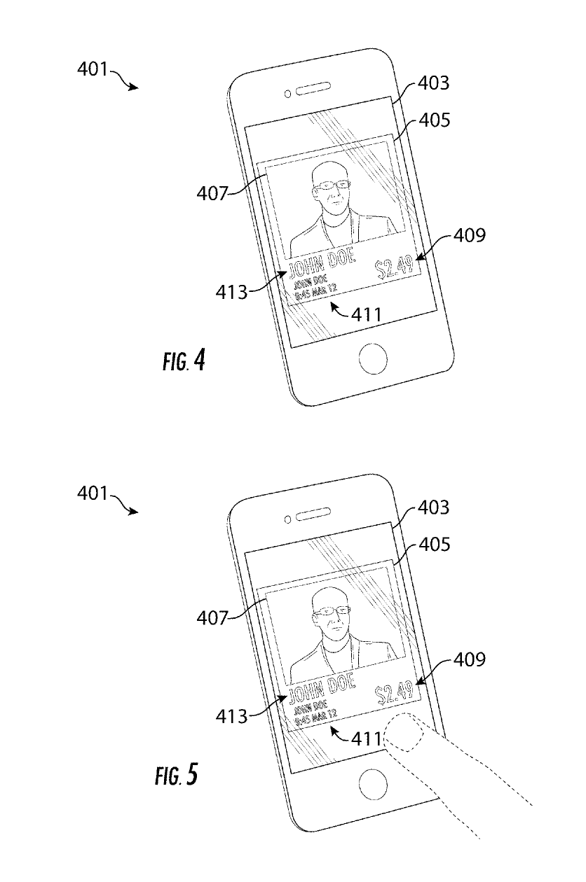

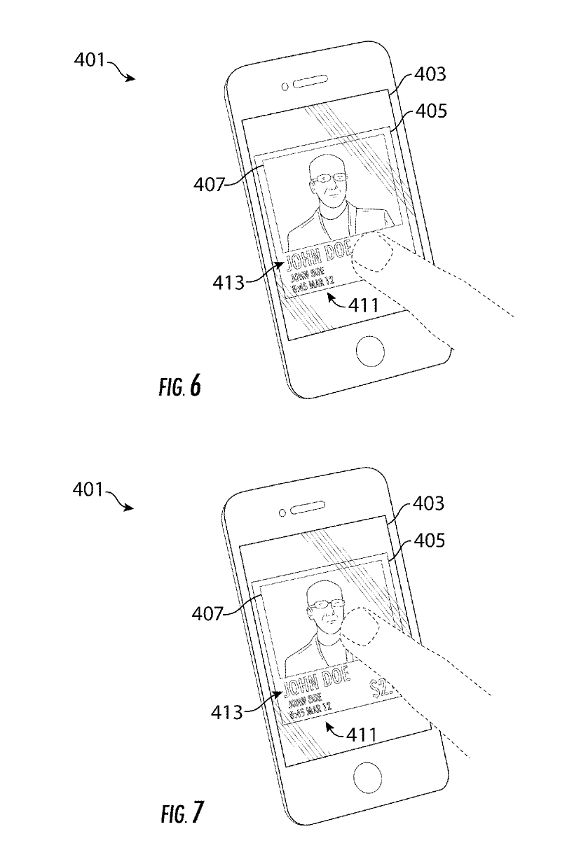

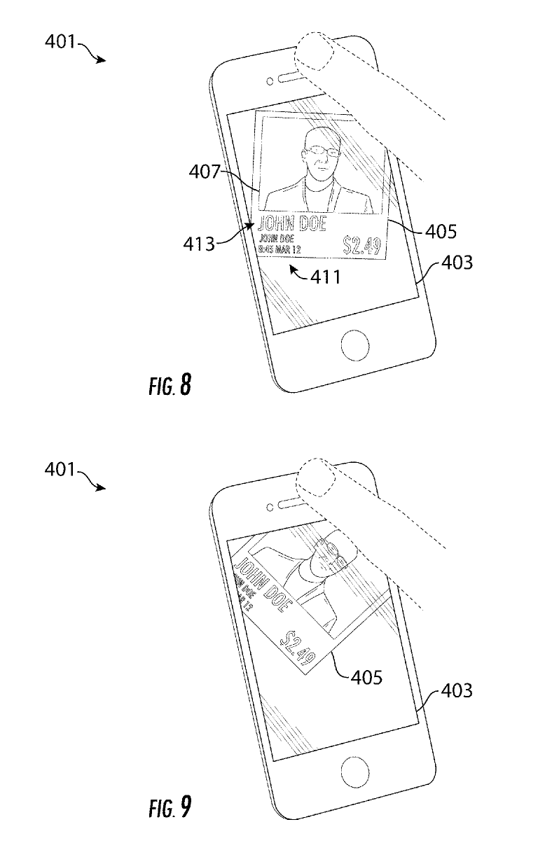

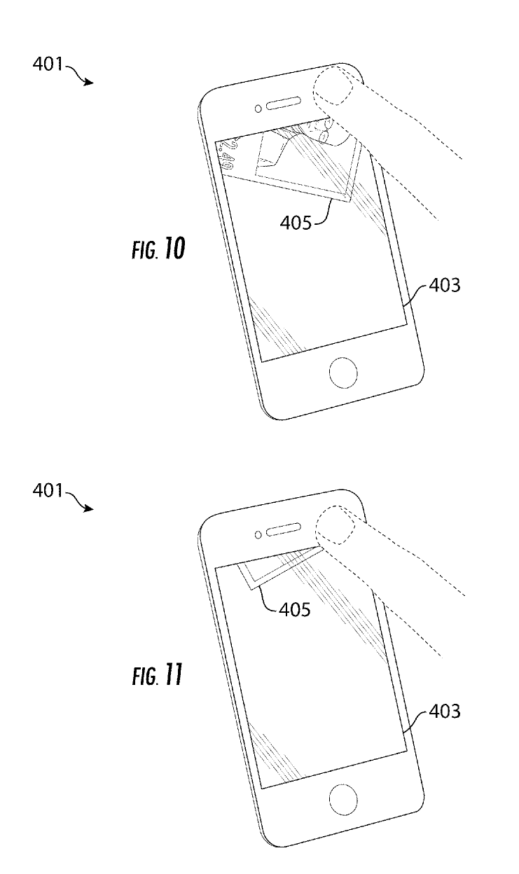

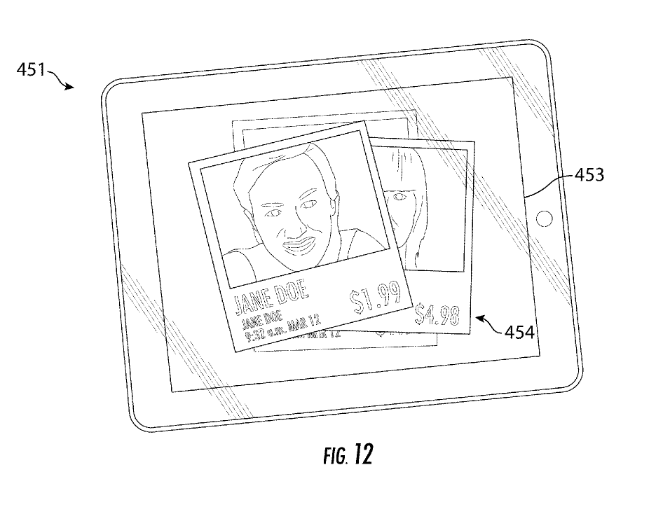

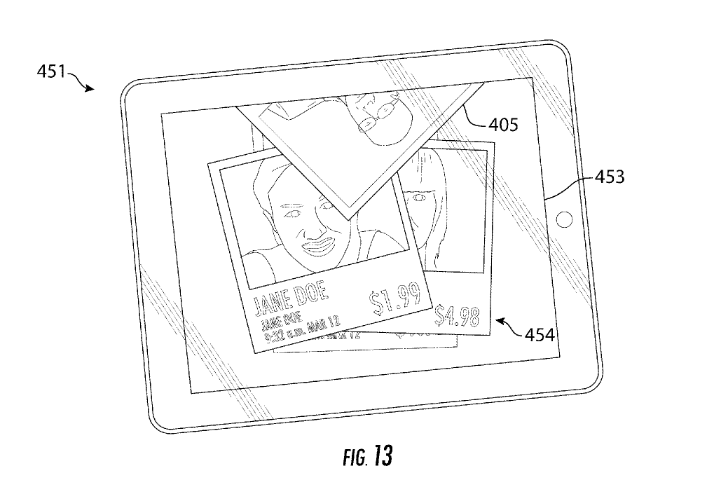

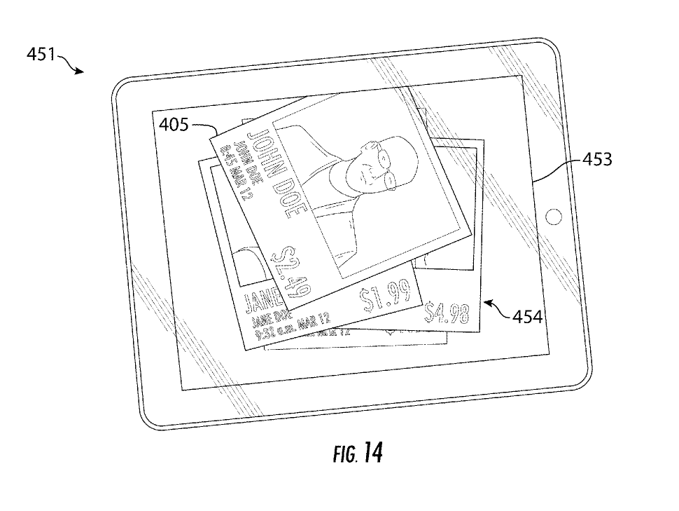

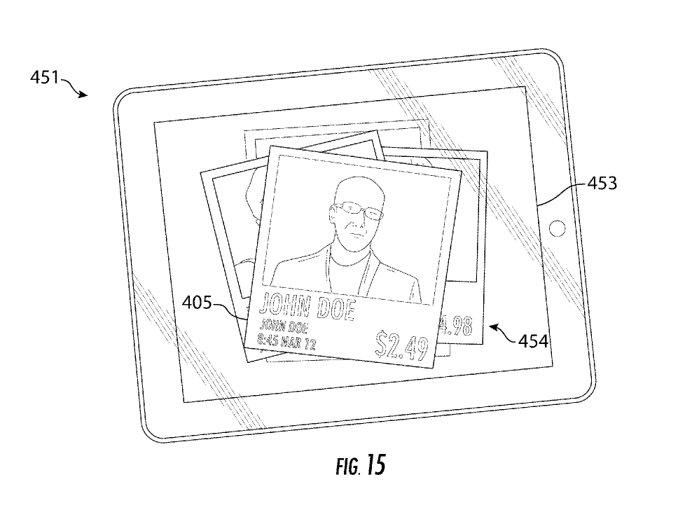

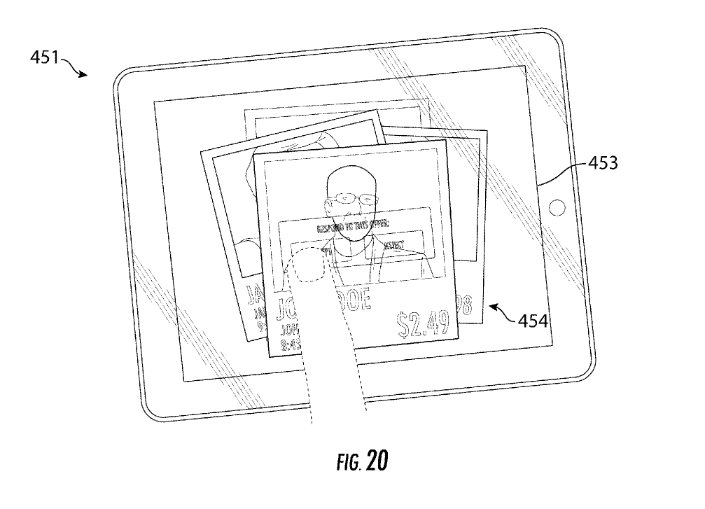

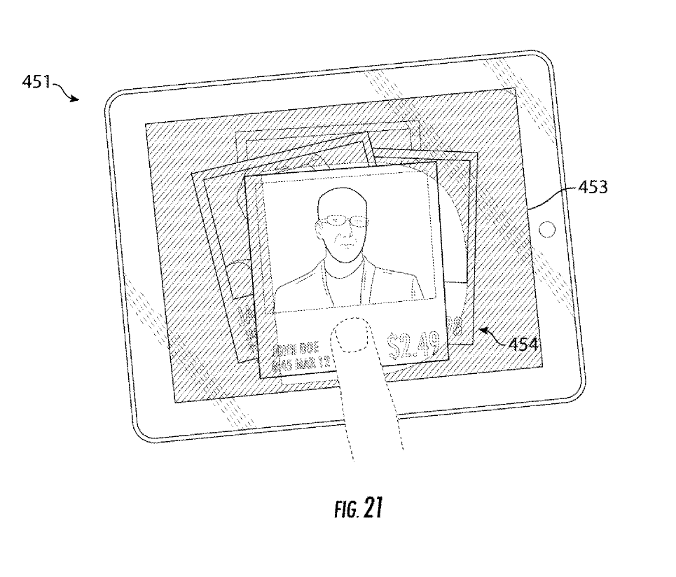

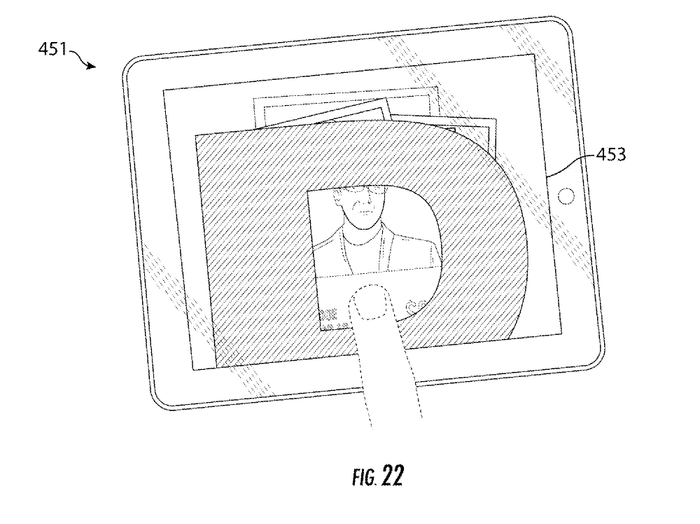

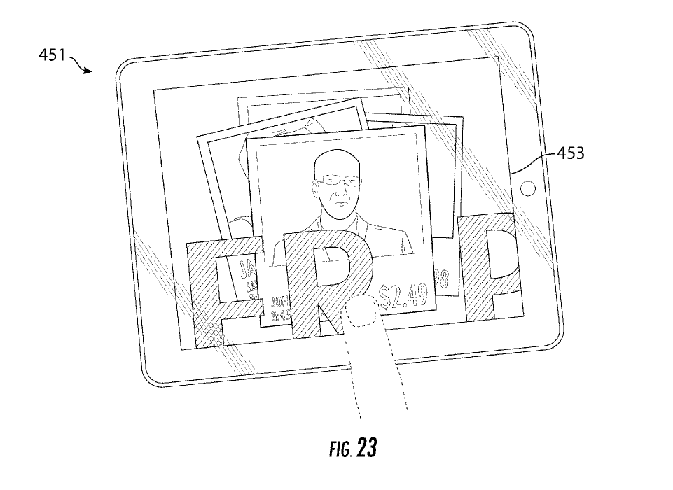

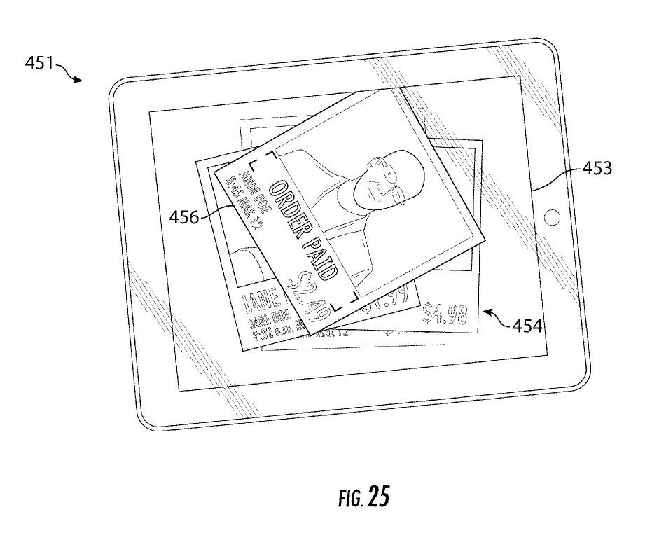

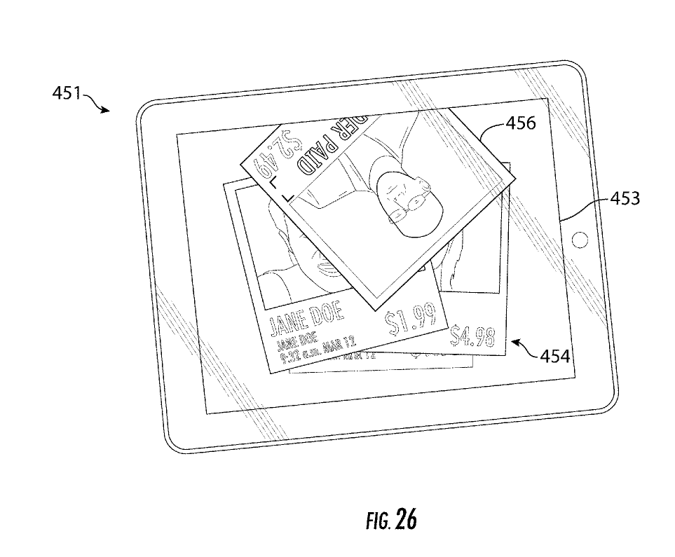

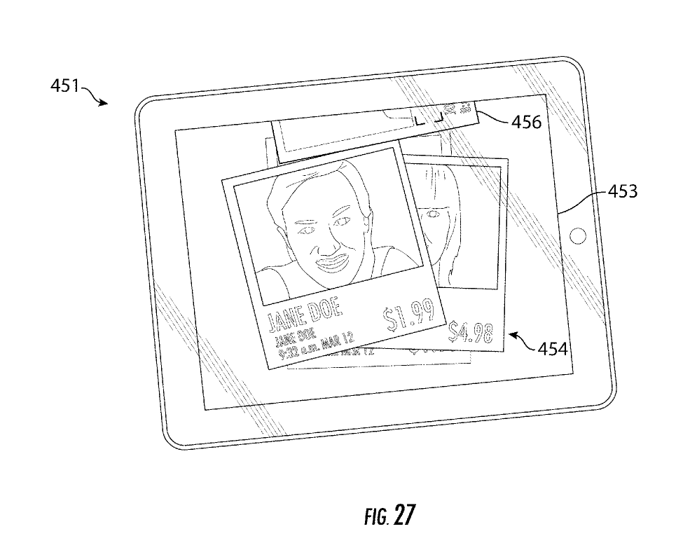

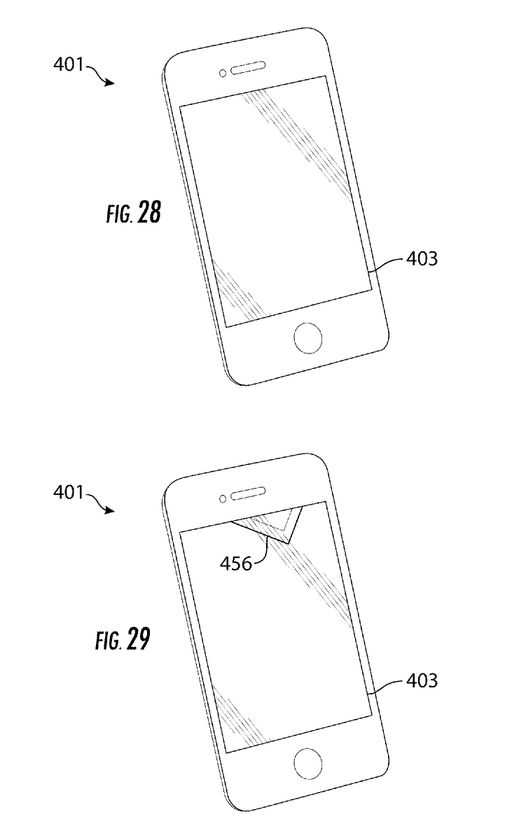

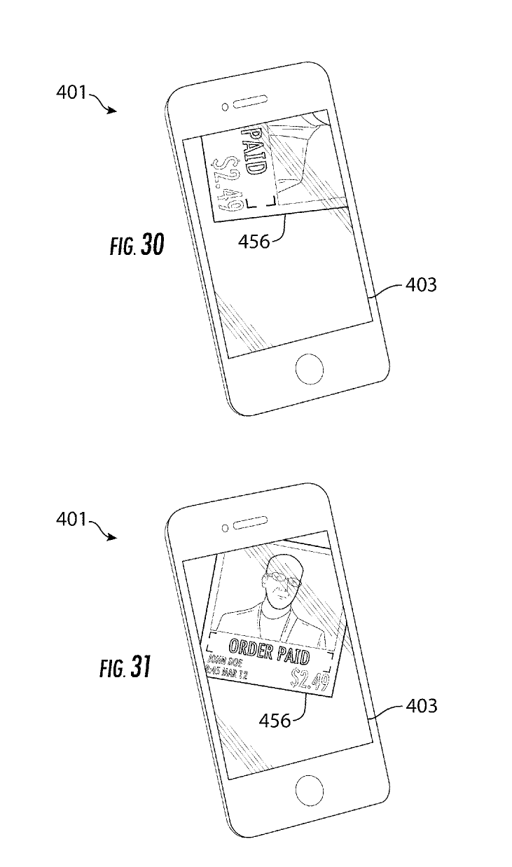

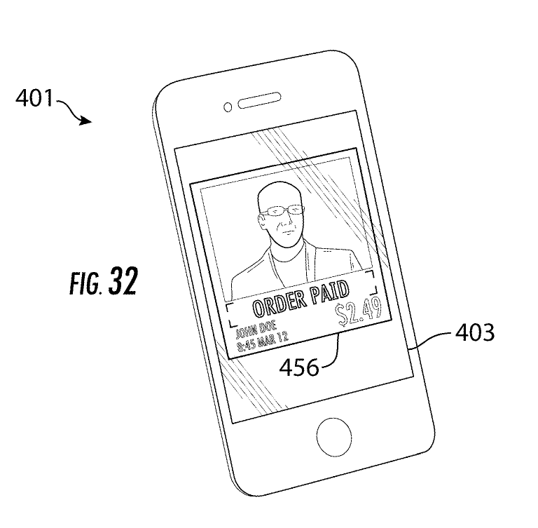

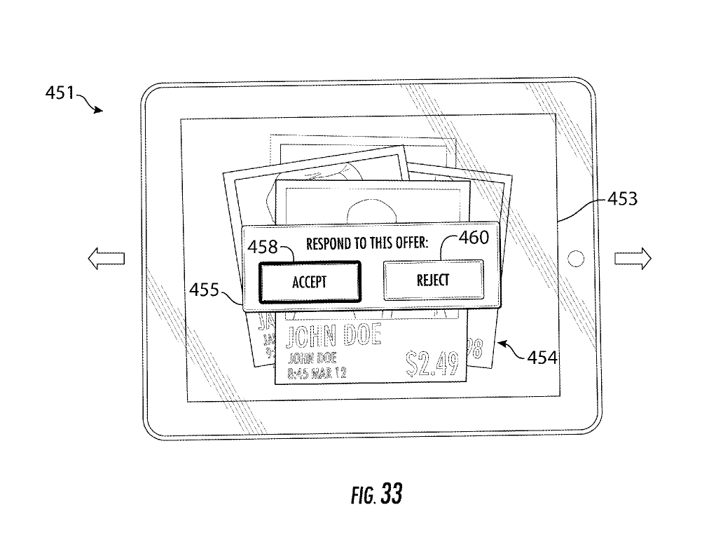

FIGS. 4-32 illustrate a particular, non-limiting embodiment of a software program utilized to implement some of the methodologies disclosed herein. The software is illustrated and explained in the context of a consumer purchasing goods (such as, for example, a cup of coffee) from a merchant. However, it will be appreciated that the systems and methodologies disclosed herein may be utilized in a variety of face-to-face transactions between various parties. Thus, for example, these systems and methodologies may be utilized in transactions involving a consumer and a merchant, two consumers, or two merchants.

In the illustrated example, the consumer has a first instance of the software client installed on his mobile technology platform, and the merchant has a second instance of the software client installed on its technology platform (the latter of which is preferably a check-out register, but may also be a PC or a mobile technology platform).

As seen in FIGS. 4-11, an “offer” 405 (in this case, an offer to pay the merchant for the goods being purchased) is rendered on the display 403 of the consumer's mobile technology platform 401. The offer 405 in this embodiment is a virtual object that includes a photo 407 of the consumer, the price 409 of the goods or services being purchased, the time and date 411 of the purchase, and the name 413 of the party making the offer.

The offer may be generated by the consumer by, for example, entering appropriate information on a screen, selecting a button or icon, entering a keystroke, or through various combinations of the foregoing. The offer may also be generated by the software upon receipt of information from the merchant. As an example of the latter possibility, the merchant may “invite” an offer by, for example, sending payment information to the user, which the software may use (possibly after the invitation is accepted) to generate the offer. Alternatively, the mobile technology platform may obtain the information required to generate the offer by other means, such as by scanning a bar code, reading a visual indicia, through voice recognition, or by downloading a menu or catalog of items which are selectable by the user. As an example of the latter, the software client may be adapted to automatically download (or request permission to download) a menu or catalog of items which are selectable by the user when the user comes within a certain proximity of the vendor.

As seen in FIGS. 5-11, if the consumer is satisfied with the offer 405, the user may use a suitable sending means to send the offer 405 to the merchant. Preferably, this sending means includes the illustrated finger gesture by which the consumer “flings” the offer in the direction of the merchant. This gesture causes the offer 405, which preferably has the appearance of a card, to exit the top of the display 403 of the consumer's mobile technology platform 401, and to twirl (preferably in a clockwise fashion) as it does so. This manner of displaying the transmission of the offer 405 is aesthetically interesting in that it replicates the motion sometimes seen when an experienced card dealer deals playing cards.

The use of this finger gesture is advantageous in that it provides a simply, yet unequivocal, means by which the consumer may indicate that the offer 405 is ready and should be transmitted to the merchant. Of course, it will be appreciated that, in variations of this embodiment, various other gestures, keystrokes, buttons, selections or commands may be used to accomplish a similar end.

In some embodiments, the software client may be configured such that the offer 405 will only be transmitted if the finger gesture is in the direction of the merchant or the merchant's technology platform 451. In variations of such embodiments, one or more proximity variables, functions, routines or algorithms may be defined that interpret the gesture input by the consumer for the purposes of determining whether the finger gesture is close enough to the direction of the merchant or the merchant's technology platform 451 to qualify as an indication that the consumer intended the offer 405 to be sent to that merchant or technology platform 451.

As seen in FIGS. 12-16, by “flinging” the offer 405 to the merchant, the consumer causes the offer 405 to appear on the display 453 of the merchant's technology platform 451. Preferably, the offer 405 appears at the top of the merchant's display 453 and rotates (preferably in a counterclockwise manner) as it does so. Thus, FIG. 12 shows the merchant's screen prior to receiving the offer 405 (at this point, the screen may be largely blank, it may be populated by other offers that have not yet been responded to, or it may be populated by the likenesses of patrons who have selected goods or services, but have not yet received cost information from the merchant), and FIGS. 13-16 show the manner in which the offer 405 appears on the screen of the register. As seen therein, the offer 405 appears the same way on the display 453 of the register as it does on the display 403 of the consumer's mobile technology platform 401, although in some variations of this embodiment, the offer 405 may appear differently depending on which display it is rendered on.

In some embodiments, the second device may be incapable of displaying a photo of the first party. This may be the case, for example, if the second device is a legacy device. In such cases, after the first user's payment information has been authorized, the first user may be prompted to display their photo to the second party. The second party may then “capture” the transaction details to show that they have verified the identity of the first party.

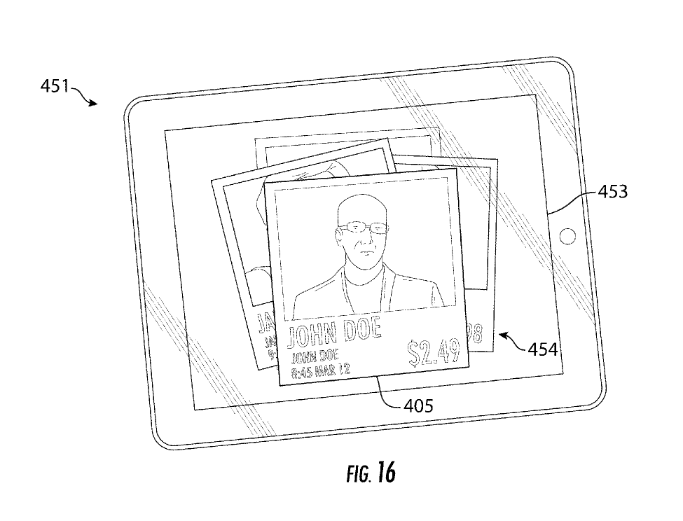

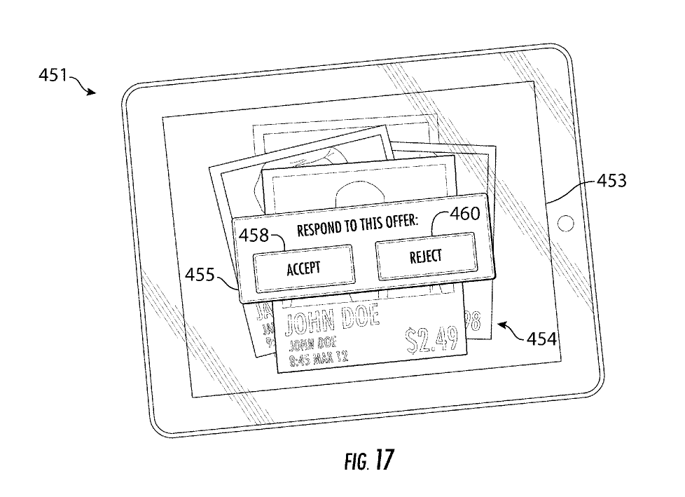

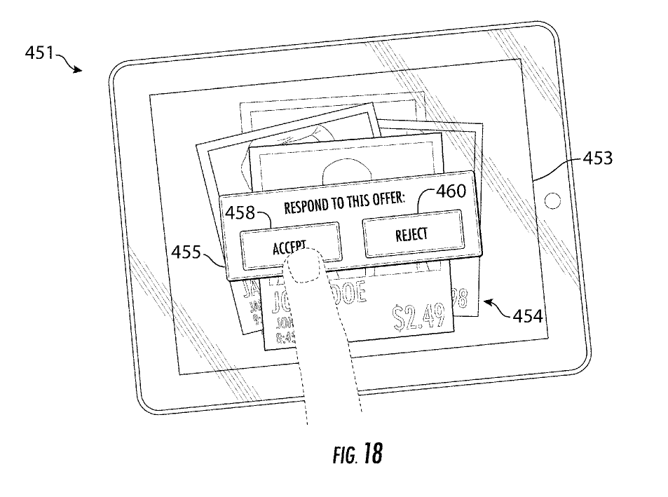

In the event that the merchant's display 453 is already populated by one or more previously received offers awaiting disposition, the offers are preferably arranged in a stack 454. Preferably, the offers are stacked in a staggered fashion as seen in FIG. 16 so that the number of offers awaiting disposition may be readily ascertained. Preferably, the offers have a bottom edge which is straight, and even more preferably, the offers are rectangular in shape, and the offers are preferably arranged so that the bottom edge of the top offer is parallel with an edge (preferably the bottom edge) of the display 451. The remaining offers may be staggered horizontally, vertically or rotationally to make the total number of outstanding offers more readily apparent.

Preferably, the offers are ordered in the stack 454 as a function of their time of receipt, so that the most recently received offer is disposed to the top of the stack 454 where its full contents are displayed. However, in some embodiments, the offers may be disposed in the stack 454 in the reverse order, with the most recently received order at the bottom of the stack 454. In some embodiments, offers that have expired may be automatically removed from the stack 454. In other embodiments, color coding may be utilized to indicate the relative length of time that the offer has been pending. In still other embodiments, offers may be given different colors to further aid the merchant in readily perceiving the total number of outstanding offers.

As seen in FIG. 17, after the offer is received by the vendor, a dialog box 455 appears on the merchant's display which gives the merchant the option of accepting or rejecting the offer. In the particular embodiment depicted, the dialog box 455 contains “Accept” 458 and “Reject” 460 buttons. However, in some variations of this embodiment (as, for example, when the system or software is integrated with a standard, Windows®-based POS system), acceptance may be inferred or implied by subsequent actions, in which case the foregoing buttons may or may not be presented. For example, in such a variation, the merchant may accept the transaction by capturing the authorized card data.

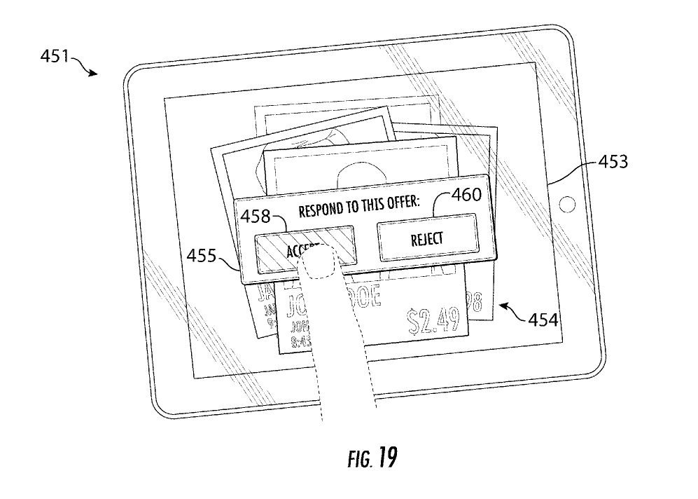

FIGS. 18-27 show the sequence of events which occur if the offer 405 is accepted. In this case, the “Accept” 458 button is highlighted to indicate its selection, and a graphics module is launched which indicates acceptance of the offer 405 by the merchant by stamping the offer with the notation “PAID”. In the illustrated embodiment, the stamped offer 456 then leaves the screen in the reverse of the manner it entered, though it will be appreciated that various other motions of the stamped offer 456 may be utilized. A similar approach may be utilized to indicate rejection of the offer 405 by the merchant, except that the “Reject” button 460 is highlighted to indicate its selection, and the offer 405 is stamped with “REJECTED” or some other suitable notation.

As seen in FIGS. 28-32, the stamped offer 456 then appears on the display 403 of the consumer's technology platform 401, where it indicates consummation of the transaction and serves as a receipt. Preferably, the accepted offer appears on the consumer's display 403 in the reverse of the motion by which it left the display 403.

Preferably, an offer made in the systems described herein will be subject to an expiration timer such that, if the offer is not accepted within a predetermined time frame, the offer will automatically expire. While the exact duration during which an offer may be accepted or may remain pending may vary from one application to another, it is preferably of a short duration. Thus, the offer will typically expire within about 5 minutes, preferably within about 2 minutes, more preferably within about a minute, and most preferably within 30 seconds.

Various means may be utilized by the second party to indicate acceptance of the offer although, as noted above, stamping the offer as accepted is preferred. For example, the offer may include a field which may be, for example, in the form of a button or icon, which the second party may select to indicate acceptance of the offer. The offer may include, alternatively or in addition, one or more hyperlinks. The software associated with the system may generate the foregoing field as part of, or separate from, the offer, or the offer may be accepted by pressing a suitable key, such as the return key. Also, as noted above, acceptance of the offer may be indicated or implied by actions undertaken by a party, such as capturing authorized card data or undertaking other actions consistent with acceptance.

Various mobile technology platforms may be utilized in the systems and methodologies described herein by one or more parties to a transaction. These mobile technology platforms include, without limitation, cell phones, PDAs, laptops, e-book readers, tablet PCs and other such devices. Preferably, the mobile technology platforms utilized are iPhones for consumers, and electronic cash registers for merchants.

The systems and methodologies described herein may utilize various means for electronically extending offers between parties to a transaction. For example, the mobile technology platforms may utilize any available networks to establish a communication link. Advantageously, however, because of the proximity attendant to a face-to-face transaction, the software may leverage the native capabilities (e.g., resident Bluetooth protocols) of the devices to establish a direct link for purposes of extending the offer and indicating its acceptance.

As part of the transaction, the mobile technology platforms may exchange a key (or keys) or a secret which may be utilized to encrypt the transmissions between them. By way of example, but not limitation, a session key may be exchanged which is valid only for the present transaction.

Some embodiments of the systems and methodologies disclosed herein may utilize facial recognition as a component of a transaction. For example, in some embodiments, the systems described herein may be integrated with standard (non-iPad-based) POS systems that require a merchant to confirm the validity of the photo on the customer's mobile technology platform before capturing a sale. In such embodiments, facial recognition algorithms may be applied to the photo for the purposes of providing such confirmation, or may be applied as additional confirmation of photo validity after the photo has been initially validated (e.g., through visual inspection) by the merchant.

The systems and methodologies disclosed herein have numerous advantages, and may be leveraged in a variety of ways. For example, the payment methods disclosed herein may be readily utilized to support customer loyalty programs. In particular, the generation of an offer on a consumer's mobile technology platform, and the receipt of an accepted offer (and the storage of accepted offers as receipts) on the same device, facilitates tracking credits that are earned under such programs by both the consumer and the merchant, and dispenses with the need for loyalty or membership cards.

The systems and methodologies disclosed herein may also be leveraged by associated software programs or program modules. For example, software may be developed which allows multiple parties to split a purchase among them, either evenly or based on the goods they actually purchased. Alternatively, the merchant may, in such a situation, readily generate invitations to each party indicating the amount they owe; these invitations may then be used by each consumer to generate offers in the amount they owe.

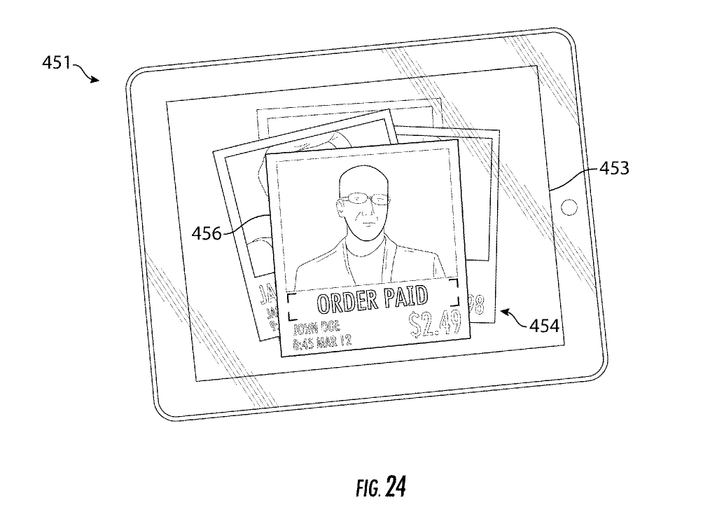

Some of the features of the systems and methodologies described herein are not particularly limited to their use in making or accepting offers, or in consummating a purchase or other financial transaction. For example, the finger gestures and associated arrangements and/or motions of objects as depicted in FIGS. 5-27 are generally applicable to the exchange, transmission, receipt, manipulation and/or marking of documents, objects or information between two or more parties and/or two or more technology platforms. This includes, for example, the finger gestures and associated arrangements and/or motions of objects and data which are associated with: (a) transmission of an offer as depicted in FIGS. 5-11, (b) receipt of an offer as depicted in FIGS. 12-16, (c) stamping, marking or otherwise denoting that an offer is accepted or paid as depicted in FIGS. 17-24, (d) transmission to the consumer of the accepted or paid offer as shown in FIGS. 24-27, (e) receipt of the accepted or paid offer by the consumer as shown in FIGS. 28-32, and (f) the arrangement of offers on a display as shown in FIGS. 12 and 15.

In some embodiments of the systems and methodologies disclosed herein, a motion (preferably implemented by a user as a flick of the wrist) may be utilized as user authorization to undertake a certain action or actions. For example, this motion, which may or may not be direction specific, may be utilized to initiate a transaction, to send an offer, to indicate acceptance of an offer, or to perform other such actions. This motion may be recognized by the host device by way of one or more accelerometers or gyroscopes contained therein, or by a combination of accelerometers and gyroscopes. For example, the Apple iPhone 4 is equipped with a three-axis gyro and accelerometer, which work in concert to detect motion of the device with a high level of precision.

Software access to the readings of accelerometers or gyroscopes in a host device may be provided by a suitable application programming interface (API). For example, in Apple's iOS 4.2, the JavaScript API provides the objects DeviceMotionEvent and DeviceOrientationEvent which allow a program to obtain, respectively, acceleration and orientation data from the host device. This sensor data may then be read by registering the respective callbacks. Thus, the device's accelerometer data may be read using the following snippet:

```
window.ondevicemotion = function(event) {
      ax = event.accelerationIncludingGravity.x
      ay = event.accelerationIncludingGravity.y
      az = event.accelerationIncludingGravity.z
      rotation = event.rotationRate;
      if (rotation != null) {
            arAlpha = Math.round(rotation.alpha);
            arBeta = Math.round(rotation.beta);
            arGamma = Math.round(rotation.gamma);
      }
}
```

Similarly, the device's gyroscope may be read using the following snippet:

```
window.ondeviceorientation = function(event) {
      alpha = Math.round(event.alpha);
      beta = Math.round(event.beta);
      gamma = Math.round(event.gamma);
}
```

The foregoing sensor data may be utilized by a program to determine whether motion of the device indicates user authorization to undertake a certain action. Preferably, authorization is context-sensitive, and hence, authorization is inferred from a qualifying motion only when authorization has been requested or is expected.

A qualifying motion may be determined with respect to specified ranges for one or more parameters. For example, a qualifying motion may comprise a motion along an axis which exceeds a minimum acceleration threshold or a minimum displacement threshold, or both, and/or which is less than a maximum acceleration threshold or a maximum displacement threshold, or both. Moreover, the displacement need not be linear, but may be angular.

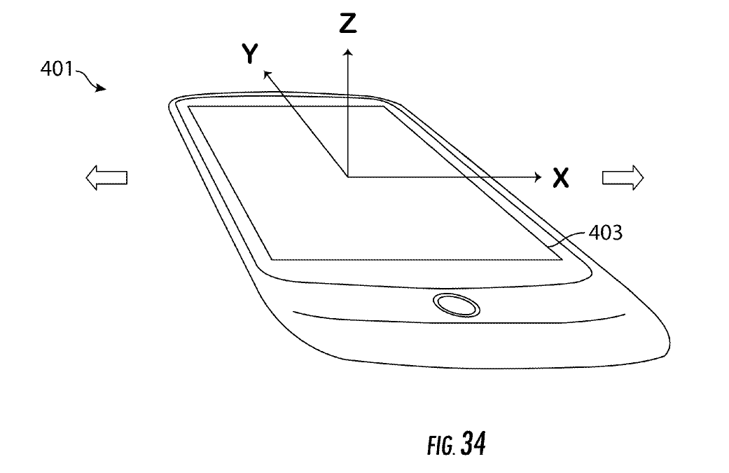

FIGS. 33 and 34 illustrate a particular, non-limiting embodiment of a qualifying motion on mobile technology platforms of the type depicted in FIGS. 4-32. In the particular embodiment depicted, in order to constitute as a qualifying motion, the motion must exceed a minimum acceleration along the x-axis (see FIG. 34). If it does, then the highlighted “ACCEPT” button in the dialog box is deemed to have been selected. Of course, it will be appreciated that various other means may be used to indicate that the device is in condition to receive acceptance of a course of action from the user including, without limitation, a shading or coloring of the display, a portion thereof, or an item rendered thereon. It will further be appreciated that acceptance may occur without display of a dialog box.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A system for transferring funds between first and second participants to a face-to-face transaction, comprising:
a software program, a first instance of which is installed in a first non-transitory, computer readable medium disposed on a first mobile communications device associated with the first participant, and a second instance of which is installed in a second non-transitory, computer readable medium disposed on a second device associated with the second participant; wherein said software program contains suitable programming instructions which, when executed, allow the second participant to receive an offer of payment sent by the first participant from the first mobile communications device such that the offer is displayed on the second device, wherein said offer indicates the amount of payment associated with the offer and contains an image of the first participant, and wherein said offer is accompanied by an acceptance indicia which, when selected by the second participant, results in the transfer of funds from an account associated with the first participant to an account associated with the second participant.

2-34. (canceled)

35. A method for consummating a financial transaction between first and second parties to a face-to-face transaction, wherein the first and second parties have first and second technology platforms associated with them, respectively, and wherein the first technology platform is a mobile technology platform, the method comprising:
receiving, on the second technology platform, an offer transmitted by the first party from the first mobile technology platform, the offer having associated therewith an indicated amount and a photo of the first party; and
accepting the offer.

36. The method of claim 35, wherein accepting the offer includes selecting a field associated with the offer, and wherein the field is selected from the group consisting of hypertext, radio buttons and icons.

37-39. (canceled)

40. The method of claim 35, wherein the offer is extended by a first instance of a software client resident on the first technology platform, and wherein the offer is accepted by a second instance of the software client resident on the second technology platform.

41-45. (canceled)

46. The method of claim 35, wherein the offer of payment is in the form of a virtual object, and wherein the offer is sent by the first party to the second party in response to a first gesture by the first party which includes running a finger across a first display associated with the first technology platform, and wherein the gesture includes running a finger from a bottom portion to the top portion of the first display.

47. (canceled)

48. The system of claim 46, wherein the virtual object moves across the first display in response to the first gesture and exits along a first edge of the first display, and wherein the first edge is the top edge of the display.

49-50. (canceled)

51. The method of claim 48, wherein the object rotates as it moves across the first display.

52. The method of claim 46, wherein the second device is equipped with a second display, and wherein the virtual object enters the second display across a first edge thereof and moves across the second display before coming to a resting place.

53. (canceled)

54. The method of claim 52, wherein the object rotates as it moves across the first display.

55. The method of claim 48, wherein the second device is equipped with a second display, wherein the virtual object is displayed on the second display when it is received, and wherein the second participant is prompted to accept or reject the offer.

56. The method of claim 55 wherein, when the second participant accepts the offer, it is stamped with a visual indicia indicating the acceptance of the offer.

57. The method of claim 55, wherein the second device is equipped with a second display, and wherein the visual indicia undergoes a transformation from a first size that is too large to fit on the second display to a second size that is small enough to fit on the second display.

58. The method of claim 56 wherein, after the offer is accepted, the stamped offer moves across the second display before exiting across a first edge thereof and is transmitted to the first participant, and wherein the stamped offer rotates as it moves across the second display before exiting across a first edge thereof.

59-61. (canceled)

62. The method of claim 58, wherein the transmitted, stamped offer enters the first display along an edge thereof and moves across the first display before coming to rest in a position on the first display.

63. The method of claim 58, wherein the transmitted, stamped offer rotates as it moves across the first display.

64. (canceled)

65. The method of claim 58, wherein the stamped offer rotates as it moves across the second display before exiting across a first edge thereof.

66. (canceled)

67. The method of claim 1, wherein the offer of payment is in the form of a virtual object, wherein the second party receives a plurality of offers from a plurality of other parties, wherein each of said plurality of offers is in the form of a virtual object, and wherein said virtual objects are stacked on a display associated with the first technology platform.

68. The method of claim 67, wherein the plurality of offers are staggered in the stack, and wherein the most recently received of the plurality of offers is disposed at the top of the stack.

69. (canceled)

70. The method of claim 35, wherein accepting the offer includes moving the second device in a qualifying motion that meets a predetermined set of criteria, and wherein the qualifying motion is selected from the group consisting of (a) motions that exceed a predetermined acceleration, and (b) motions that exceed a predetermined displacement.

71-73. (canceled)

74. A method for consummating a financial transaction between first and second parties in a face-to-face setting, wherein the first and second parties have first and second technology platforms associated with them, respectively, and wherein the first technology platform is a mobile technology platform, the method comprising:
generating, on the first technology platform, an offer having associated therewith an indicated amount and a photo of the first party; and
transmitting the offer to the second technology platform.

75-86. (canceled)
